(19) United States
(12) Patent Application Publication
(10) Pub. No.: US 2016/0121968 A1
(43) Pub. Date: May 5, 2016

(54) CHAINLESS MULTI-STAGE DERAILLEUR DEVICE

(71) Applicant: Ching-Yi Lin, New Taipei City (TW)

(72) Inventor: Ching-Yi Lin, New Taipei City (TW)

(21) Appl. No.: 14/530,842

(22) Filed: Nov. 3, 2014

(51) Int. Cl. B62M 11/04; B62M 25/00; F16H 3/02; B62M 17/00

(52) U.S. Cl. CPC B62M 11/04; B62M 17/00; B62M 25/00; F16H 3/02

(57) ABSTRACT

The present invention provides a chainless multi-stage derailleur device free from stuck-chain, de-railed chain and other issues for various bicycles. The technological means includes: a derailleur device on the sprocket shaft of bicycle rear wheel; and a driving device connected with derailleur device; it is characterized: the derailleur device has a driven member on sprocket shaft with the first elongated hole at the edge; a drive member located on one side of the driven member for rotation; and a control device engaging with the drive member to control drive member the decrease or increase of the moment of inertia. In this way, the speed of the bicycle will change due to the increase or decrease of rotation momentum when the rider pedals the bicycle with the same power. Therefore, by increasing the screw length of the derailleur device, the multi-stage gear changes of 20, 30, and 40 can be realized. It overcomes the barrier of transmission by chain and solves the structure and weight issues of ratchet.

### BACKGROUND OF INVENTION

1. Field of the Invention

The present invention relates generally to a derailleur device, and more particularly to a chainless multi-stage derailleur device, which can be installed in a bicycle to get rid of the stuck-chain and de-railed chain issues.

2. Description of Related Art

A growing number of manufacturers have developed and launched a variety of new bicycles. However, the main transmission is mainly realized by the chain connected with the pedal sprocket and the rear sprocket. It is widely known that the transmission mode of chain and sprocket, can easily result in the stuck-chain, de-railed chain and sprocket wear and tear. Moreover, the damage to pants or skirts caused by chain or sprocket often occurs, leading to some inconvenience and distress in riding.

Therefore, the industry has developed and designed the chainless bicycle transmission mode. However, such a bicycle is generally of a single-speed drive. As it cannot provide the speed shifting effect in the case of riding on a slope, it is laborious to ride and thus it cannot compete with the traditional bicycles of chain and sprocket.

For this reason, how to address the above problems and develop a chainless multi-stage derailleur device free from stuck-chain, de-railed chain and other issues to work with a variety of bicycles has become the research topic of the present invention.

### SUMMARY OF THE INVENTION

The objective of the present invention is to provide a chainless multi-stage derailleur device free from stuck-chain, de-railed chain and other issues to work with a variety of bicycles.

To address the above issues and realize the purpose of the present invention, the technological means is described as follow: it is a chainless multi-stage derailleur device, comprising: a derailleur device installed on the rear sprocket shaft of the bicycle; and a driving device connected with the derailleur device at one end to rotate the derailleur device; it is characterized: the derailleur device comprises a driven member disposed at the sprocket shaft and there is the first elongated hole extending outwardly at the edge; a drive member installed on the sprocket shaft on the side of the driven member to rotate the driven member; and a control device engaging the drive member to control drive member the decrease or increase of the moment of inertia; the drive member contains a ratchet on the outer wall of the sprocket shaft and there is the second elongated hole extending outwardly in correspondence with the first penetrated hole at the edge of the ratchet wall. On one side of the second elongated hole, there is a C-shaped retaining member. On the side wall of the retaining member, there is the third elongated hole corresponding to the first and the second elongated holes. At the top and bottom of both ends of the retaining member, there are two through holes. In between the through holes, there is a screw, on which there is a slider going through the first, the second and the third elongated holes to rotate the driven member. At the top of the screw, there is a sprocket seat engaging the control device and control the upper and lower displacements of the screw; the control device contains [symbol] -shaped control piece engaging the sprocket seat. At both ends of the control piece, there are two toggle pieces controlling the rotation of the sprocket seat. At one side of the control piece, there is a fixed mount combined with the bicycle frame to fix the control piece. Therefore, when the driving device rotates the drive member, the sprocket seat will be rotated through the control piece by the toggle piece and force the screw to move the slider upwardly and downwardly. When the slider moves upward, the derailleur device's momentum of rotation will increase. On the contrary, when the slider moves downward, the derailleur device's momentum of rotation will decrease. In this way, the speed of the bicycle will change due to the increase or decrease of rotation momentum when the rider pedals the bicycle with the same power.

Compared with the prior art, the function and effect of the present invention are as follows:

First: the present invention mainly depends on the control device to control the increase or decrease in rotation momentum of the drive member and the driven member to change speed to realize the multi-stage speed changing function without the need of sprocket. Therefore, there are no stuck-chain, de-railed chain and other issues.

Second: the present invention can be applied in various types of bicycles without the need to change the structure. It can fit well with the original bicycle frame and ratchet without replacing frame and ratchet. Hence, it has good applicability and can realize the low cost and high economic practical value. It has overcome the barrier of required special frame for the chainless multi-stage derailleur devices.

### BRIEF DESCRIPTION OF THE DRAWINGS

FIG. 1: a perspective view of the present invention.

FIGS. 2, 3: exploded views of the present invention.

FIGS. 4˜6: schematic embodiment of the operation of the present invention.

FIG. 7: schematic perspective view of a bicycle with the present invention.

### DETAILED DESCRIPTION OF THE INVENTION

The embodiment is described in details according to the diagrams:

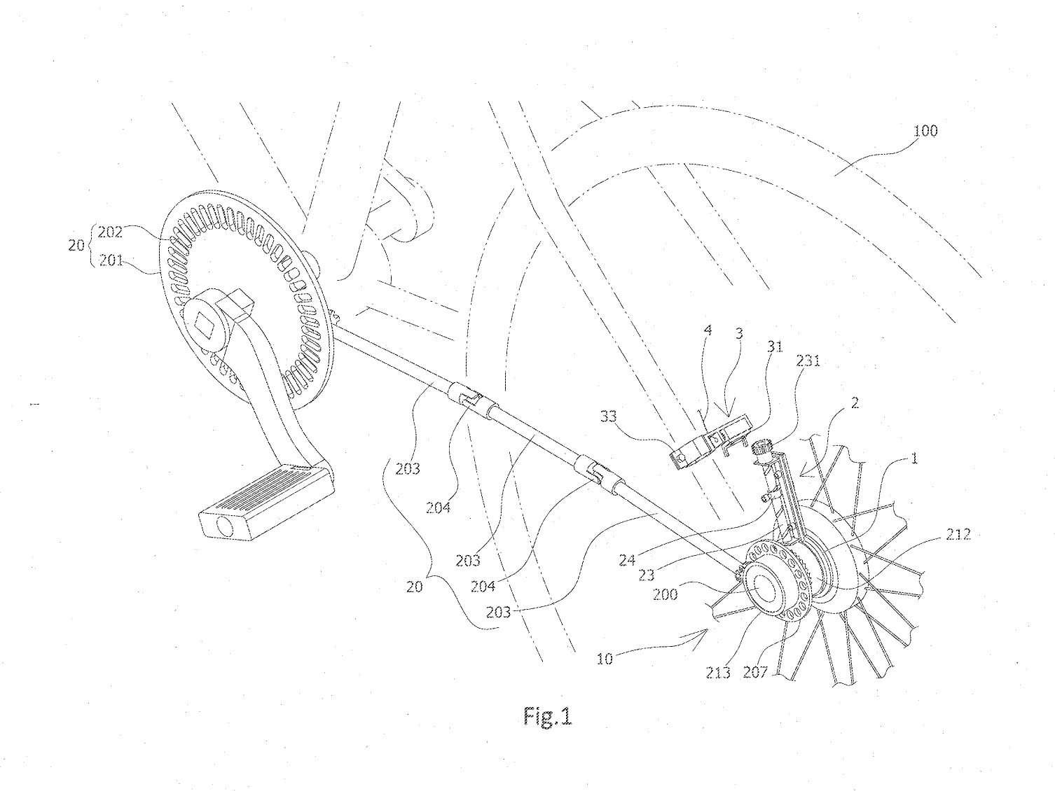

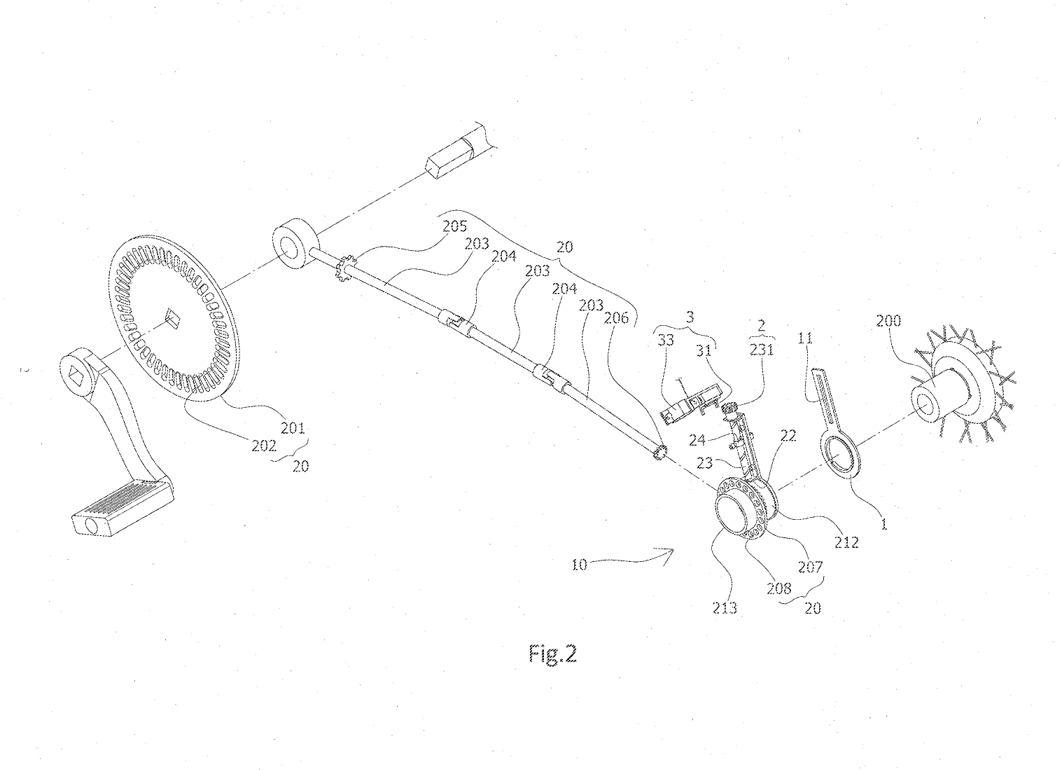

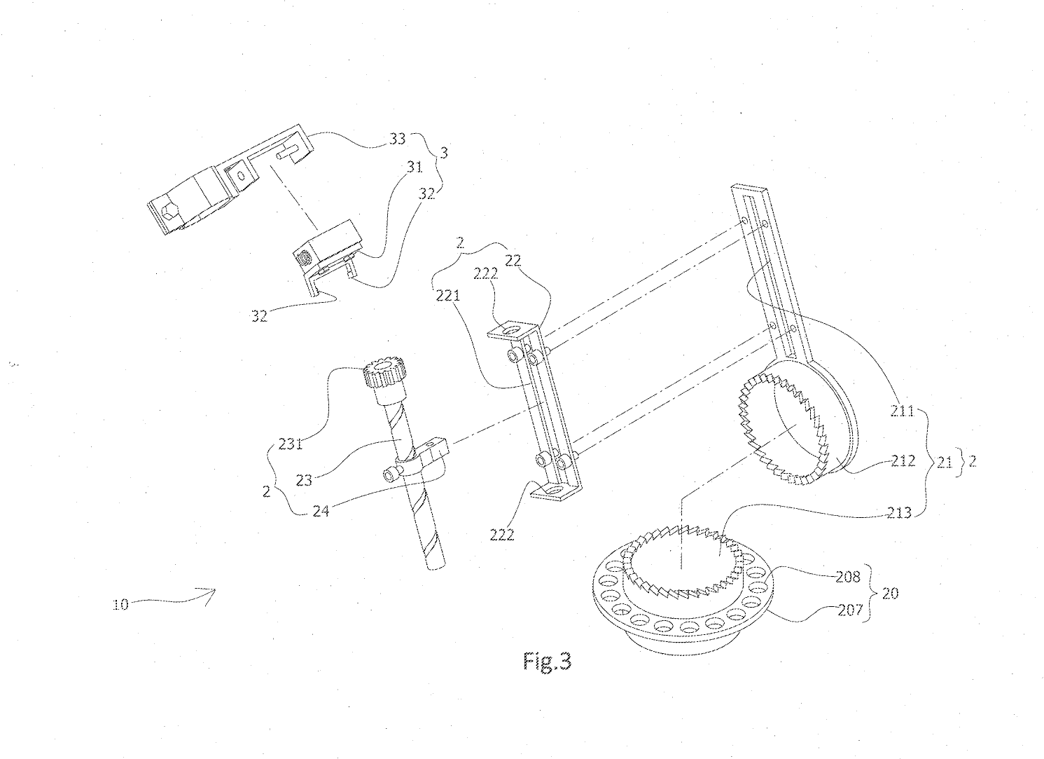

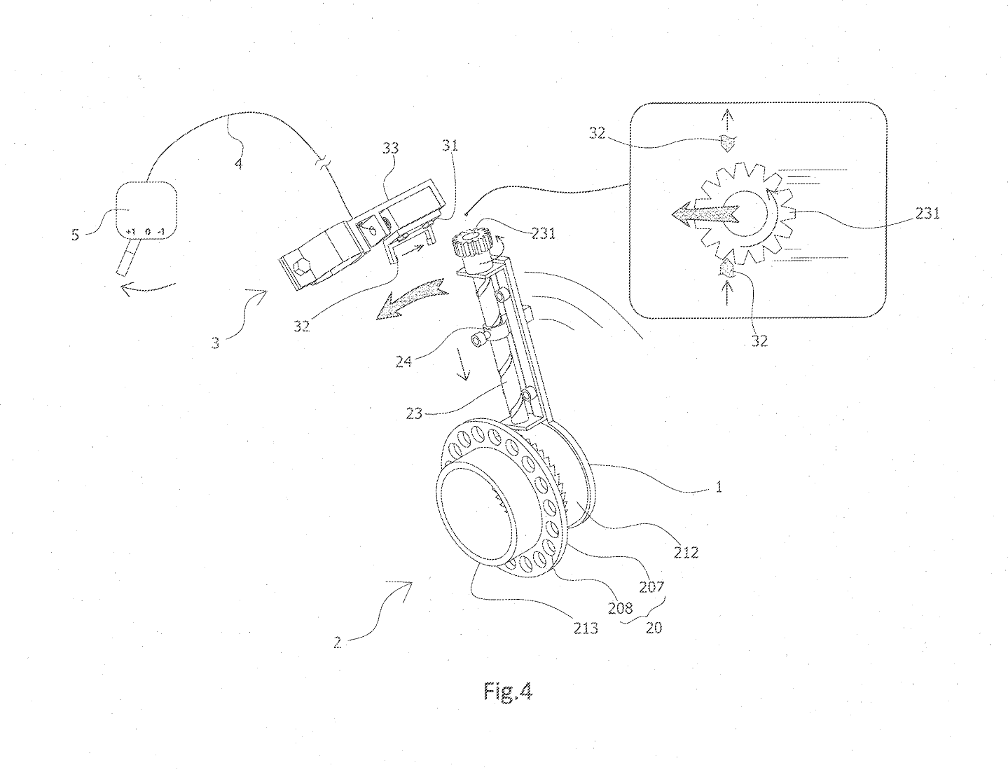

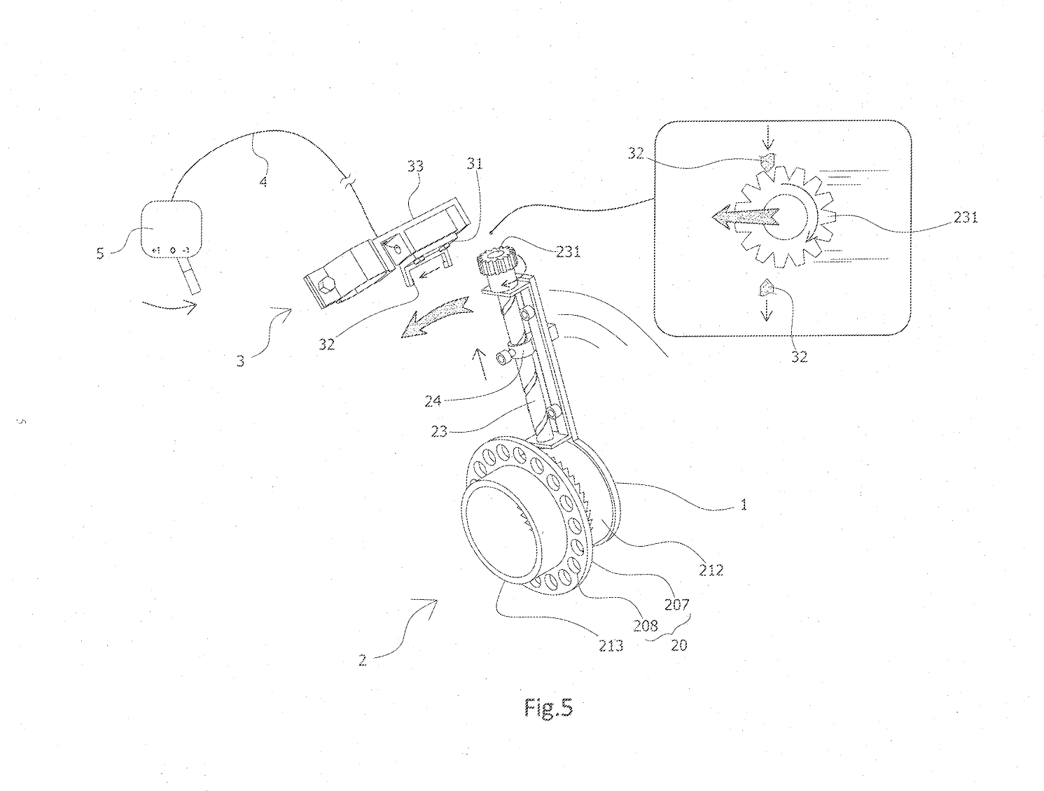

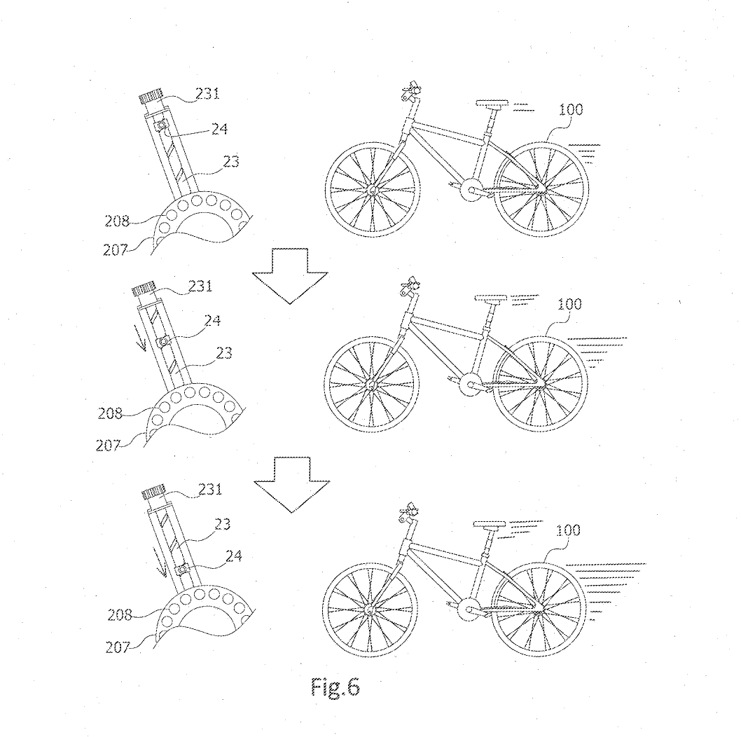

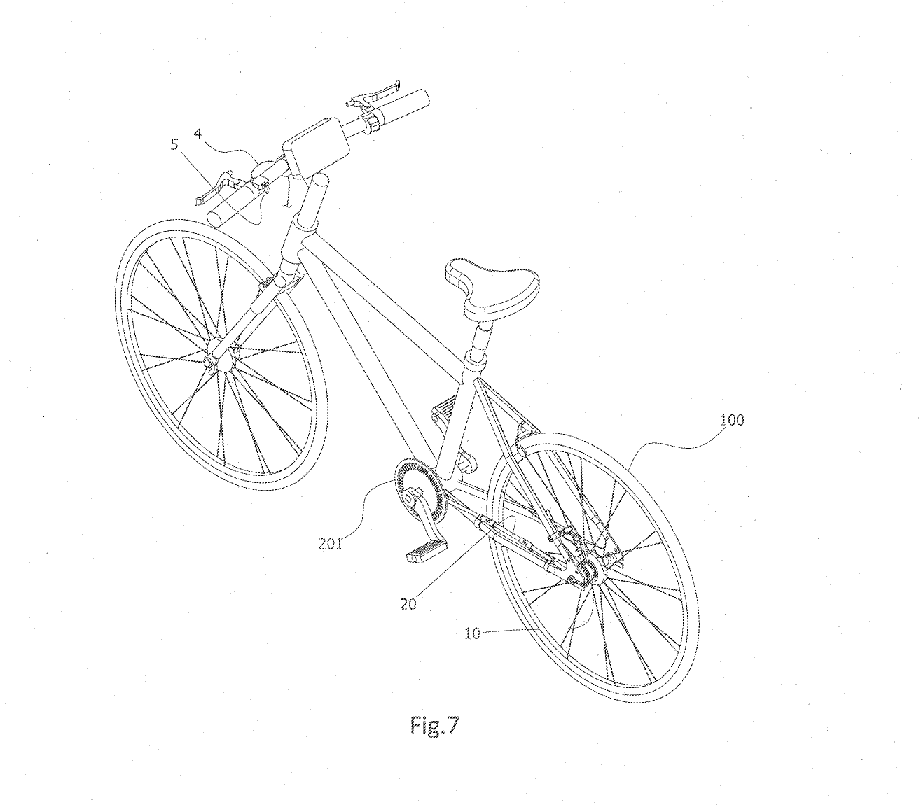

As shown in FIGS. 1˜7, a chainless multi-stage derailleur device, comprising: a derailleur device 10 mounted on sprocket shaft 200 of bicycle rear wheel 100; and a driving device 20 connected with the derailleur device 10 at one end to rotate the derailleur device 10; it is characterized: the derailleur device 10, comprising: a driven member 1 installed on the sprocket shaft 200 with the outward extending the first elongated hole 11 at the edge; a drive member 2 installed on the sprocket shaft 200 at one side of the driven member 1 to rotate the driven member 1; and a control device 3 engaging the drive member 2 to control the decrease or increase of the moment of inertia of the drive member; the drive member 2, comprising: a ratchet 21, the ratchet 21 installed on the outer wall of the sprocket shaft 200, at the edge of the side wall of the ratchet 21, there is the second elongated hole 211 in correspondence with the first elongated hole 11. On one side of the second elongated hole 211, there is a C-shaped retaining member 22, on the side wall of the retaining member 22, there is the third elongated hole 221 in correspondence with the first and second elongated holes 11, 211. At the top and bottom of the retaining member 22, there are through holes 222, in between the through holes 222, there is a screw 23, the screw 23 has a slider 24 going through the first, second and third elongated holes 11, 211, 221 to rotate the driven member 1. At the top of the screw 23, there is a sprocket seat 231 engaging the control device 3 to control the upward and downward displacement of the screw 23; the control device 3, comprising: a [symbol] -shaped control piece 31 engaging the sprocket seat 231, at both ends of the control piece 31, there are two toggle pieces 32 to rotate the sprocket seat 231, on one side of the control piece 31, there is a fixed mount 33 engaging the bicycle frame to fix the control piece 31; the ratchet 21, comprising a driven ratchet 212 on the sprocket shaft 200 and a driving ratchet 213 engaging with each other in correspondence to the driven ratchet 212.

Wherein, by the implementation of the above structure, when the driving device 20 rotates the drive member 2, the sprocket seat 231 will be rotated through the control piece 31 by the toggle piece 32 and force the screw 23 to move the slider 24 up and down. When the slider 24 moves upwardly, the momentum of rotation of the derailleur device 10 will increase; on the contrary, when the slider 24 moves downwardly, the momentum of rotation of the derailleur device 10 will decrease. In this way, the speed of the bicycle will change due to the increase or decrease of rotation momentum when the rider pedals the bicycle with the same power.

Secondly, through the decrease and increase of the length of screw 23, the derailleur device 10 gears can be changed. When the screw 23 length is longer, the range of up and down displacement of the slider 24 will be greater. Therefore, the multi-stages of the derailleur device 10 will increase. On the contrary, when the screw 23 is shorter, the range of up and down movement of the slider 24 will be smaller, and thus the number of variable stages of the derailleur device 10 will become relatively lower.

Moreover, through the design of ratchet 21 and fixed mount 33, the derailleur device 10 can be applied in various types of bicycles without the need to change the structure. It can fit well with the original bicycle frame and ratchet without replacing frame and ratchet. Hence, it has good applicability and can realize the low cost and high economic practical value. It has overcome the barrier of required special frame for the chainless multi-stage derailleur devices.

The driving device 20 contains a drive disk 201 connected with the bicycle pedal pivot with a few engagement rings 202 on its surface, a link mechanism 203 engaging the drive disk 201 with at least one universal joint linkage 204; the first gear 205 at one end of the link mechanism 203 to engage the engagement ring 202; the second gear on the other end of the link mechanism 203; and a driven disc 207 engaging the second gear 206 with a few engagement holes 208.

Wherein, when the force generated by drive disk 201 can be transmitted to the second gear 206 through the first gear 205 and the link mechanism 203 to rotate the drive member 2 and driven member 1 to realize the power transmission of the bicycle.

On one end of the control device 3, there is a bicycle cable 4, on the other side of the bicycle cable 4; there is a control device operation shaft 5.

Wherein, control device operation shaft 5 can control the left, right or relocation movement of the control piece 31. When the drive member 2 rotates through the control piece 31, the sprocket seat 231 of the drive member 2 will be pushed by the toggle piece 32 to force the screw 23 to move the slider 24 upward and downward to change the increase or decrease in rotation momentum of the driven member 1 to change the speed without sprocket. Therefore, there will be no stuck-chain, de-railed chain and other issues.

Although the invention has been explained in relation to its preferred embodiment, it is to be understood that many other possible modifications and variations can be made without departing from the spirit and scope of the invention as hereinafter claimed.

I claim

1. A chainless multi-stage derailleur device, comprising:
a derailleur device (10) on a sprocket shaft (200) of bicycle rear wheel (100); and a driving device (20), wherein one end of the driving device (20) connected with the derailleur device (10) to rotate the derailleur device (10), which is characterized in that
the derailleur device (10) including
a driven member (1) disposed at the sprocket shaft (200) and having a first elongated hole (11) extending outwardly at the edge thereof;
a drive member (2) installed on the sprocket shaft (200) and arranged on one side of the driven member (1) to rotate the driven member (1); and
a control device (3) engaging the drive member (2) to control drive member (2) the decrease or increase of the moment of inertia;
the drive member (2) including a ratchet (21) arranged on the outer wall of the sprocket shaft (200), said ratchet (21) comprising a second elongated hole (211) extending outwardly in correspondence with the first elongated hole (11) and disposed at an edge of a side wall of the ratchet (21);
a C-shaped retaining member (22) arranged in one side of the second elongated hole (211), said retaining member (22) including a third elongated hole (221) arranged in the one side wall thereof and corresponding to the first and the second elongated holes (11, 211), and through holes (222) disposed respectively at a top surface and a bottom surface thereof;
a screw (23) arranged between the two through holes (222);
a slider (24) disposed in the screw (23) and going through the first, the second and the third elongated holes (11, 211, 221) to rotate the driven member (1); and
a sprocket seat (231) disposed at a top of the screw (23), and engaging the control device (3) and control the upper and lower displacements of the screw (23);
the control device (3) including a [symbol] -shaped control piece (31) engaging the sprocket seat (231);
two toggle pieces (32) disposed at two ends of the control piece (31) for controlling the rotation of the sprocket seat (231);
a fixed mount (33) disposed at one side of the control piece (31) and combined with the bicycle frame to fix the control piece (31); therefore, when the driving device (20) rotated the drive member (2), the sprocket seat (231) will be rotated through the control piece (31) by the toggle piece (32) and force the screw (23) to move the slider (24) upwardly and downwardly; when the slider moved upward, the momentum of rotation of the derailleur device (10) will increase and vice versa, when the slider moved downward, the momentum of rotation of the derailleur device (10) will decrease, in this way, the speed of the bicycle will change due to the increase or decrease of rotation momentum when the rider pedals the bicycle with the same power.

2. The device defined in claim 1, which is characterized in that said driving device (20) comprises a drive disk (201) connected pivotally with the bicycle pedal having a plurality of engagement rings (202) on its surface;
a link mechanism (203) engaging the drive disk (201) in one end thereof and having at least one universal joint (204);
a first gear (205) disposed at one end of the link mechanism (203) to engage the engagement ring (202);
a second gear (206) disposed at the other end of the link mechanism (203); and
a driven disc (207) engaging the second gear (206) with a plurality of engagement holes (208).

3. The device defined in claim 1, which is characterized in that one end of the control device (3) is further connected with a bicycle cable (4), and on the other end of the bicycle cable (4) is provided with a control device operation shaft (5) controlling the left, right or relocation movement of the control piece (31).

4. The device defined in claim 1, which is characterized in that the ratchet (21) comprises of a driven ratchet (212) on the sprocket shaft (200), and a driving ratchet (213) disposed in correspondence to the driven ratchet (212) and engaging with each other.
